(19) United States
(12) Patent Application Publication
(10) Pub. No.: US 2019/0212570 A1
(43) Pub. Date: Jul. 11, 2019

(54) Dual Magnification Viewing System

(71) Applicant: Spectrum Optix Inc., Calgary (CA)

(72) Inventors: John Daugela, Calgary (CA); Darcy Daugela, Calgary (CA); Gadi Amit, San Francisco, CA (US); Brandon Joseph DesRoches, Edmonton (CA); Nathan Michael Ryhard, St. Albert (CA)

(21) Appl. No.: 16/242,399

(22) Filed: Jan. 8, 2019

Related U.S. Application Data
(60) Provisional application No. 62/614,890, filed on Jan. 8, 2018.

(51) Int. Cl. G02B 27/02; G02B 27/00; G02B 27/10

(52) U.S. Cl. CPC G02B 27/027; G02B 27/1066; G02B 27/0075

(57) ABSTRACT

A viewing system includes a first optics system having a first aperture size and a first field of view, and optics that provide a lightpath to a first sensor. The optics system has a second optics system having a second aperture sized to be less than the first aperture size, and a second field of view greater than the first field of view; the second optics system providing a lightpath to a second sensor. Also provided is a display switchable between a first view mode in which a wide field image provided by the second sensor is displayed, and a second view mode in which a narrow field image provided by the first sensor is displayed.

### RELATED APPLICATIONS

This application claims the benefit of U.S. Provisional Application Ser. No. 62/614,890, filed Jan. 8, 2018, which is hereby incorporated herein by reference in its entirety for all purposes.

### TECHNICAL FIELD

The present disclosure relates to a viewing system that provides for image and video capture of wide field and narrow field magnified views in a handheld device. The viewing system provides some of the functionality of a binocular system with associated high-resolution image and video capture.

### BACKGROUND

While binoculars and monoculars are widely available, there are few consumer grade binoculars or monoculars that can also take high resolution pictures or videos using the same optics. Most available devices provide only low-resolution image and/or video capture.

### SUMMARY

A viewing system includes a first optics system having a first aperture size and a first field of view of less than 15 degrees (typically between 1 and 15 degrees), and optics that provide a lightpath to a first sensor. The optics system has a second optics system having a second aperture sized to be less than the first aperture size, and a second field of view greater than the first field of view; the second optics system providing a lightpath to a second sensor. Also provided is an integrated display held in a case supporting the first and second optics system, the integrated display switchable between a first view mode in which a wider-field image provided by the second sensor is displayed, and a second view mode in which a narrower-field image provided by the first sensor is displayed. In some embodiments, either the first or second optics systems can optionally include folded lightpath optics.

In one embodiment, widefield images and narrow field images can be simultaneously captured as at least one of single frames (picture) or a series of frames (video).

In one embodiment, at least one of a mechanical, electrical, or software switch is used to toggle between first and second modes.

In one embodiment, a target reticle on the display is provided in the first view mode, with an area within the target reticle corresponding to the narrow field image.

In one embodiment, electronics supporting a downloadable application able to modify viewing system functionality are provided.

In one embodiment, a communication system able to stream image or video data is provided.

In one embodiment, a communication system able to simultaneously communicate with one or more of a viewing device, smartphone, or other connected devices to transfer image or video data is provided.

In one embodiment, electronics supporting a machine learning module are provided.

In one embodiment, a communication system able to be controlled at least in part remotely by a smartphone is provided.

In one embodiment, a water/dust proof or water/dust resistant casing is provided.

In another embodiment, a viewing system includes a hand holdable casing and a digital electronics system supported within the hand holdable casing. A first optics system with an aperture size greater than 10 mm and a narrow field of view between 1 to 15 degrees and a second optics system with a wide field of view greater than the first are positioned within the casing. Viewing of images is provided by a display connected to the digital electronics system and switchable between a first view mode in which a wide field image provided by the second sensor is displayed, and a second view mode in which a narrow field image provided by the first sensor is displayed.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIGS. 1A-D illustrates an embodiment of a viewing system;

FIG. 2 illustrates various electronic components of a viewing system;

FIG. 3 illustrates operation of an embodiment of the viewing system;

FIGS. 4A and 4B illustrates a switching view mode; and

FIGS. 5A-5D illustrate various embodiments and switch components.

### DETAILED DESCRIPTION

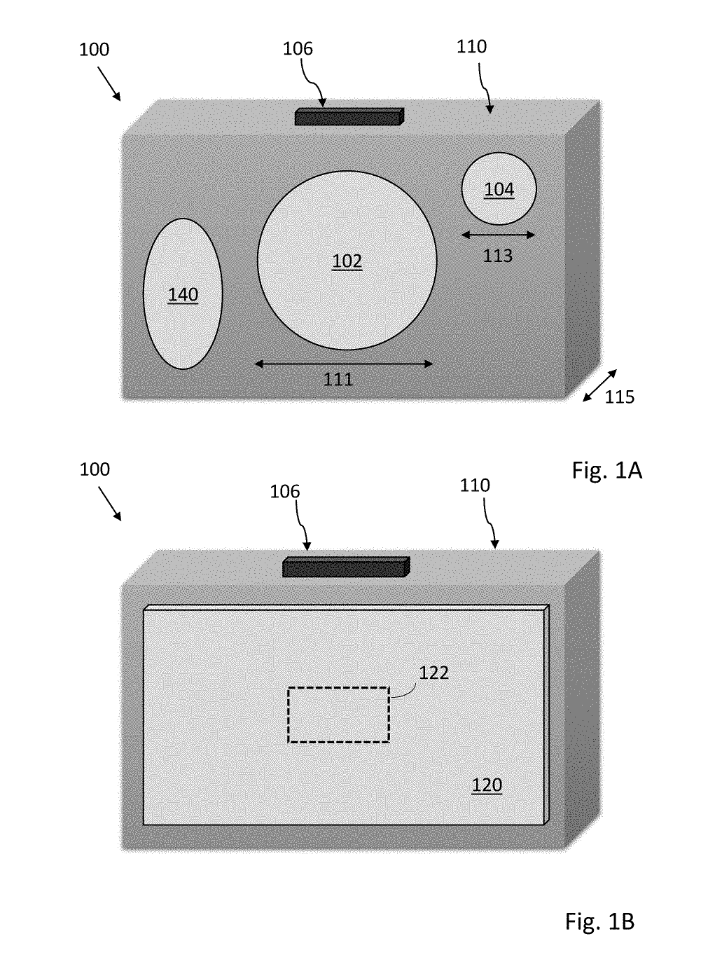

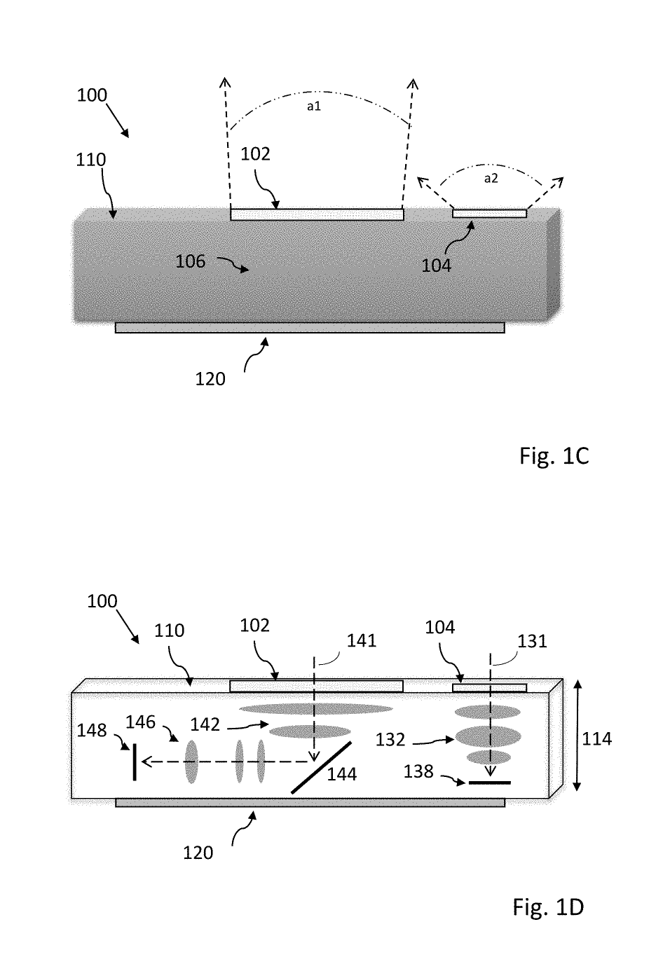

FIG. 1A illustrates one embodiment of a viewing system 100. In the illustrated embodiment, the viewing system 100 includes a case 110 with a depth 115 supporting a first lens system 102 with aperture 111 and a second lens system 104 with aperture 113. As compared to the second lens system 104, the first lens system 102 has a narrower field of view and larger aperture. Depending on mode, a control switch 106 or switches can be used to power-on, switch between viewing states, initiate image capture, review captured images, transmit images, initiate connection with a smartphone, or power-off. One or more auxiliary optics system 140 can be included, and optionally can include optical or laser rangefinders, infrared imagers, flash lighting systems, structured UV or IR light emitters and imagers.

FIGS. 1B and 1C respectively illustrate a rear and a top view of the viewing system 100 with digital electronics including sensors and a display screen 120 integrated into the case 110. The display screen 120 can switch between a wide field view provided by a sensor associated with the second lens system 104 and the magnified narrow field view provided by a sensor associated with the first lens system 102. When the wide field view is presented on the display 120, a centrally located a targeting reticle 122 can be used to indicate the portion of the display view that would be shown when switching to the magnified narrow view. In some embodiments the display screen can be a touch screen that supports icons or menus for manual control of the viewing system 100.

FIG. 1D illustrates a cutaway view of the viewing system 100 with optional folded optic pathway and sensors being shown. The widefield second lens system 104 includes multiple optics 132 that define a straight-through optical path 131 to a sensor 138. The narrow-field first lens system 102 having an optional folded optic path 141 includes a first set of optics 142, a mirror or optical element containing a reflective surface 144, second set of optics 146, and sensor 148.

As will be appreciated, while folding the optics allows for a substantial reduction in necessary depth 114 of case 110, along with increase in focal length and ability to support large lens apertures, other embodiments having straight path optics can be used.

In some embodiments, optics and sensors can be arranged to allow viewing in non-visible spectrums such as near infrared, or infrared, or ultraviolet. For example, sensors having pixels sensitive to infrared or ultraviolet wavelengths can be used. In some embodiments, use of additional filters or optics with reduced ultraviolet absorption may be required.

Advantageously, when a user holds the described viewing system 100 and directs it toward a landscape or other remote area, various levels of view are possible. For example, the display screen 120 can show a widefield view that is somewhat narrower than an eye view and has a low or moderate level of magnification with respect to the unaided eye. By engaging or actuating the control switch 106, the display screen 120 can switch to a narrow and highly magnified field highlighted by targeting reticle 122 or other suitable locating aid. The ability to retain viewing context and quickly switch between viewing modes allows, for example, a user to target and track even fast-moving objects. The ability to switch viewing modes easily using the switch 106, while keeping one or both hands holding the device stable, enables easy and rapid long range target acquisition. Interfaces that require a user to move one hand to touch a screen while holding the device with the other hand, are not as simple to use.

Use of multiple sensors enables simultaneous image capture from both lens systems 102 and 104. As compared to single sensor systems, optical layouts can be more flexible, and switching between views does not require use of complex mechanical movable optical elements or other light path redirection methods. Multiple sensors can be used to simultaneously capture and preserve both wide field and magnified views. In some embodiments, additional sensors can be used to support another magnification level or specialty lens systems, including but not limited to macro or microscopic viewing modes, or infrared modes, or range finding modes.

The case 110 can be constructed from plastic, metal, or suitable combinations of metal and plastic. Closable hatches or panels can be used to access removable batteries, memory media, charging and other input/output ports. The case 110 can be configured with grips, slip resistant textured patterns, and projecting or depressed features that improve handholding ability. Auxiliary tripod mount points can be provided. The case can be waterproof, dustproof, water resistant and/or dust resistant. In some embodiments, underscreen magnets or mechanical attachment points can be provided in the case for accessory attachment. In some embodiments, mechanical stabilization of the case 110 with gyroscopes or other suitable stabilizers can be used to improve observations. Mechanical, optical or electronic/digital stabilization methods can be implemented.

Lens systems can include either/both glass or plastic lens elements, or reflective optically powered mirrors. Symmetrical, aspheric, flat, or graded index lenses can be used, as well as advanced metamaterial/nanomaterial lenses. In some embodiments rectangular or “trimmed” rectangular lens (i.e. circular lens with top and bottom having flat sides, while left and right sides remain curved) can be used. Use of rectangular lens systems allow more light to be captured in a compact space, and to maximize the effective resolution for a given volume. The wide field lens can have a field of view from 5 to 50 degrees, with 10 to 30 degrees being typical. The narrow field lens can have a field of view from 0.5 to 20 degrees, with 1 to 10 degrees being typical. In some embodiments, optical stabilization of the lens and sensor system can be used to improve observations. In other embodiments, accessory lenses can be attached to modify effective field of view and magnification.

In addition to the described first lens system 102 with a folded path, other alternative optical path systems can be used. These can include predominantly refractive systems with one or more prisms or fold mirrors, predominantly reflective systems with multiple focusing mirrors (and optional aspheric refractive lenses to correct aberrations), or catadioptric systems that use a mixture of refractive lenses and focusing mirrors.

Typically, a display screen is a backlit LCD, OLED, or bistable screen similar to that commonly used in mobile devices such as smartphones. The screen can be about 5 to 15 centimeters in width, and can be rectangular with a 4:3, 16:9, or other width to height ratios. In alternative embodiments, square, circular, elliptical display screens can be used. In some embodiments, multiple screens can be used, or a single screen used in a split screen or tiled mode.

Various reticle designs are possible, including no reticle, rectangular reticles, circular reticles, or central dot, cross or arrow indicators. The width to length proportions of the reticle can matched to screen in some embodiments, so that switching modes from a full screen widefield view to narrow field will still fill the screen. In other embodiments, the reticle proportions can be mismatched to provide a mode indication when a full screen widefield view is switched to narrow field (i.e. the narrow field does not completely fill the display screen, giving a distinctive “zoomed in” appearance)

The control switch can be an electronic or mechanical switch and is generally positioned on the top or side of the case in such a way as to allow one or two hands to steadily hold the case. In one embodiment the switch is mechanical and uses a slide action (i.e. back and forth) to switch field of view. Image capture is initiated by a press down action. Alternative embodiments can include toggles, buttons, multiple buttons, capacitive touch or pressure switches, or any other suitable mechanism for a user to initiate view mode changes. In some embodiments a separate switch is not necessary, with a touch screen or audio control being used. The switch can be water/dust proof or water/dust resistant.

For those embodiments including a range finder based on optical, laser, or time of flight measurements, a mode that measures and displays distance between the viewing system and a target can be provided. Actual distance, horizontal distance, height, angle and vertical separation (height between two points) measurement functions can be determined.

In some embodiments, digital electronics of the viewing system can support additional sensors or output devices including but not limited to microphones, audio speakers, accelerometers, gyroscopes, magnetometers, or thermal sensors. Applications supporting a range of functions can be downloaded and installed in the digital electronics of the viewing system. For example, applications that support sharing, commenting, image processing, audio based processing, or object identification can be supported. As an example, an application having access to GPS/GNSS navigation and three-dimensional orientation from optional on-board sensors, can be used to identify constellations or individual stars in the sky targeted by the viewing system. Alternatively, or in addition, stellar pattern matching can be used to identify sky targets. In other embodiments, downloaded applications can support contests or games in which numbers of distinct birds, animals, or plants are viewed within a specific time period. Downloaded applications can support direct streaming or transfer or data, or can communicate and act in coordination with a user (or others) smartphone.

Built-in or downloaded applications can also support real-time or near real-time custom image processing. For example, in many situations, objects blend into the background or are otherwise camouflaged. Using real-time auto-contrast, color enhancement, or motion detection, an image or video can be altered to increase the likelihood that an object can be visually detected. In some embodiments, applications that provide a tracking box around moving objects, indicate direction of object movement, and/or provide continuous updating of target range and speed can be enabled in viewing systems equipped with suitable sensing systems. In other embodiments, automated mode switching between IR and visual modes can be used to improve tracking of individuals or vehicles moving between low and high light areas (e.g. cars or people moving between streetlights). In still other embodiments, applications can be used to reduce atmospheric or optical distortions.

Machine learning can be directly supported by digital electronics of the viewing system, or indirectly supported by cloud services or through connection to a local smartphone. Convolutional or recurrent neural networks can be used to identify objects, animals, or people. In some embodiments, continued use and training can improve accuracy of target identification. For example, with repeated training a machine learning system can at first only identify an object as a bird. For example, with repeated tests, field training, and confirmed identifications made in the bird's environment, the bird can be identified as a hawk, and with time, identified as a red-tailed hawk. Machine learning can also support multiple input types, including audio input. In some embodiments, the machine learning system can use the combination of a partially obscured bird image combined with detected birdsong to provide identification.

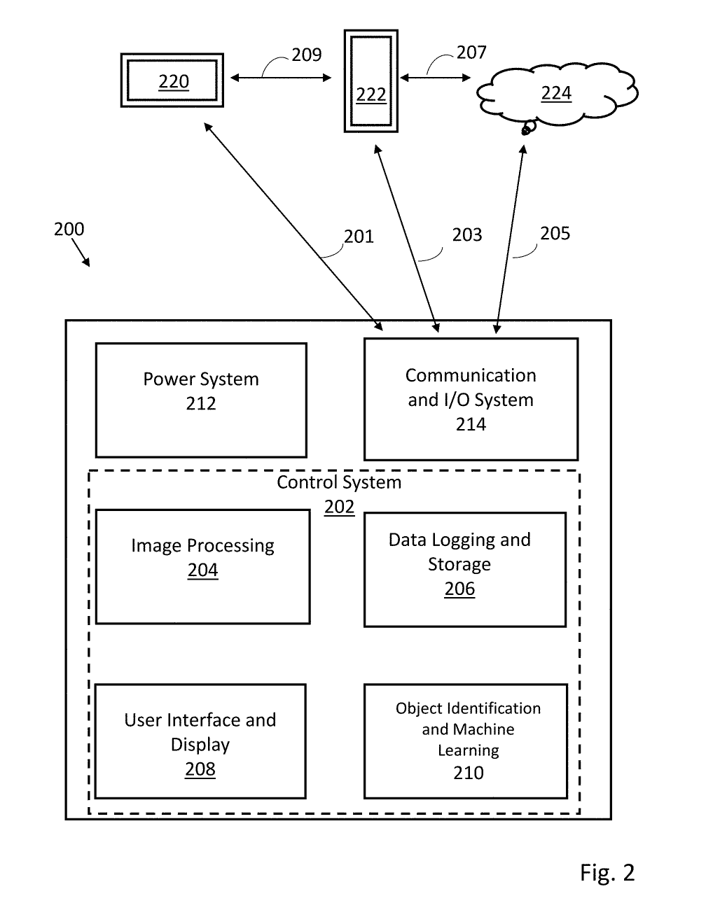

FIG. 2 illustrates a viewing system 200 with associated remote image storage and transfer to facilitate or encourage social interactions. The digital electronics of the viewing system includes a power system 212 and communication and I/O system 214. Also included are a control system 202 that includes image processing 204, data logging and storage 206, a user interface and display 208, and object identification and machine learning 210. The communication system and I/O system 214 can engage (via wireless connection 201) with another viewing system 220 to transfer images and information. Engagement with a smartphone 222 (via wireless connection 203 or a cloud service 224 (via wireless connection 205) is also possible. In some embodiments, data can be indirectly transferred. For example, using a Wi-Fi, LTE, 4G, 5G or similar connection to cloud service 224, data can be successively sent via 205, to smartphone 222 via 207, to another viewing system 220 via wireless connection 209. In some embodiments, multiple viewing systems or smartphones can simultaneously receive images and video from a selected viewing system. This allows, for example, a tour guide to provide real time video to multiple smartphones of a group of tourists. Additionally, a smartphone or other wired or wirelessly connected system can control the device's functions remotely.

Advantageously, a smartphone connection via Bluetooth or WiFi allows sending data that includes images, videos, and reticle targeting information. This data can be shared on available social media or web sites, can be live streamed in real time, or can provide a secure data backup. A smartphone or other wired or wirelessly connected system can be used for secondary or custom processing of images, including resizing, sharpening, labelling, or providing improved image contrast and colour. In other embodiments, the smartphone can provide additional information related to captured images or videos. For example, an unknown bird can be imaged with the viewing system, and identified with name and locality information using an application accessible or provided by the smartphone. A smartphone can also be used to facilitate firmware or software updates to the viewing system 200.

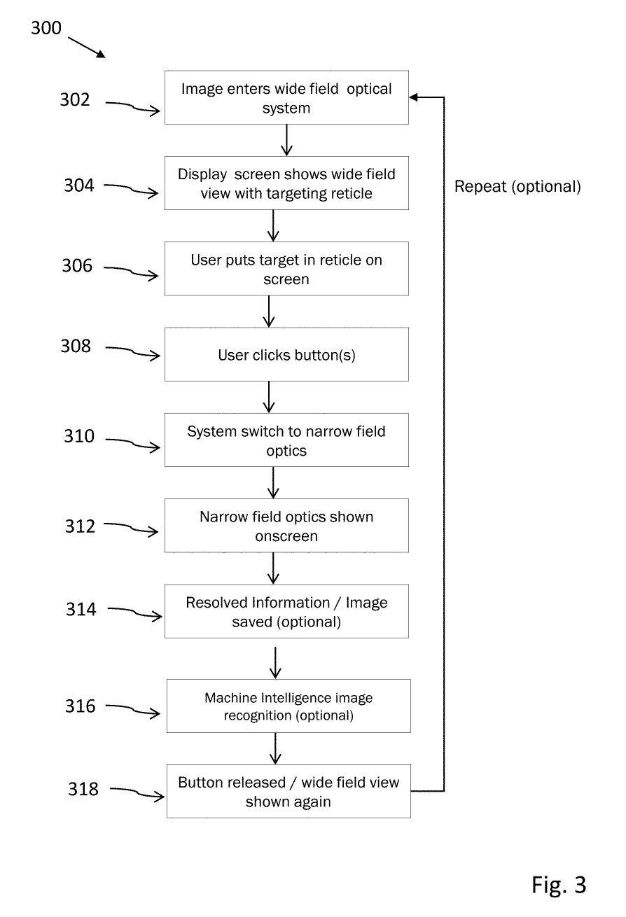

FIG. 3 illustrates a method 300 for operating a view system such as disclosed herein. In step 302 an image enters a widefield optical system and is captured by a sensor that processes the image and relays it to a display screen (step 304) that shows the widefield view with a targeting reticle. In step 306 the user aims the view system to put a target within the targeting reticle. In step 308 the user depresses or clicks a switch or button, causing (step 310) the displayed image or video to switch to that captured by a sensor associated with a narrow field optics system (step 312). In optional step 314 the image or video can be resolved and saved. In step 316, optional machine intelligence can be used for image or video or objection recognition and classification. In step 318, the switch or button is released and the widefield view is again shown, allowing the method to be repeated.

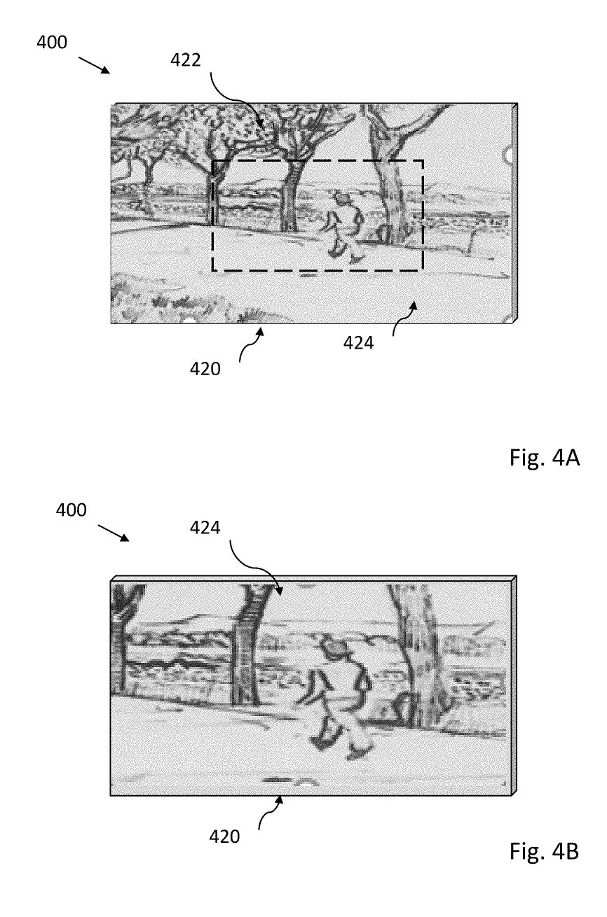

FIG. 4A illustrates a viewing system 400 with a screen display 420 and a targeting reticle 424 overlain on a widefield image 422. In FIG. 4B, the relatively magnified image within the reticle is seen as captured by the narrow field optical system. This narrow field may optionally have a colored border to indicate to the user it is using the narrow field optical system.

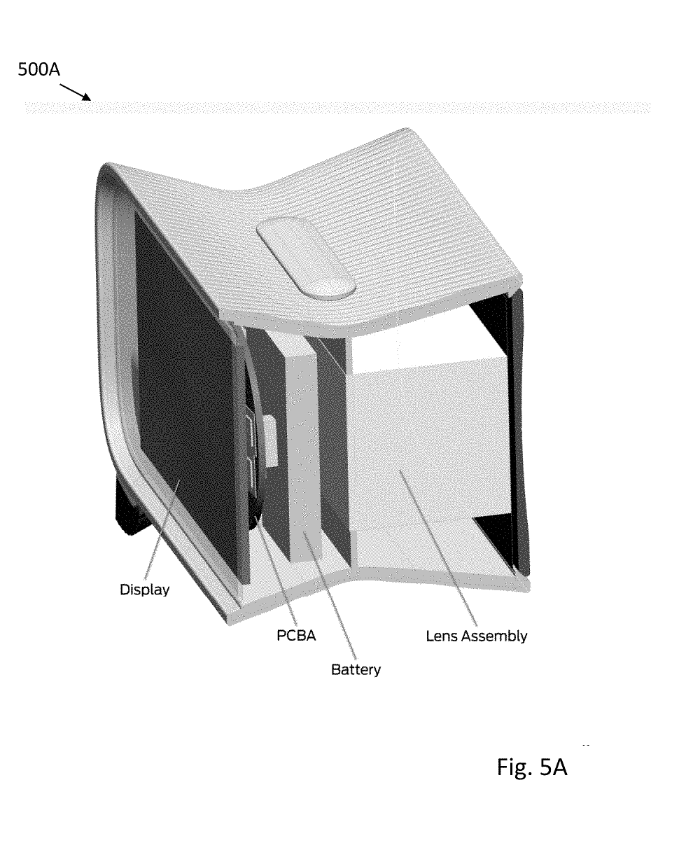

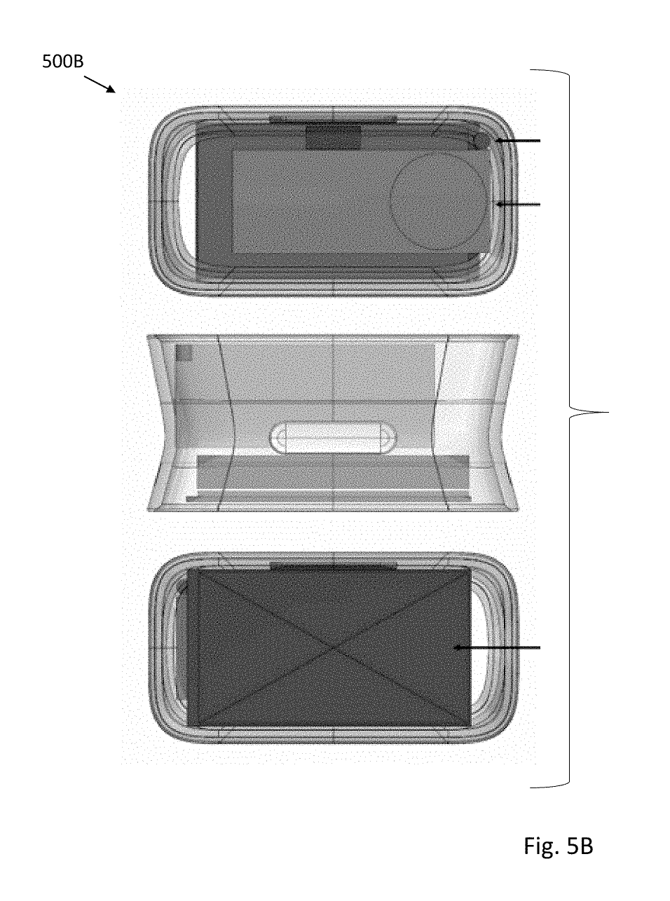

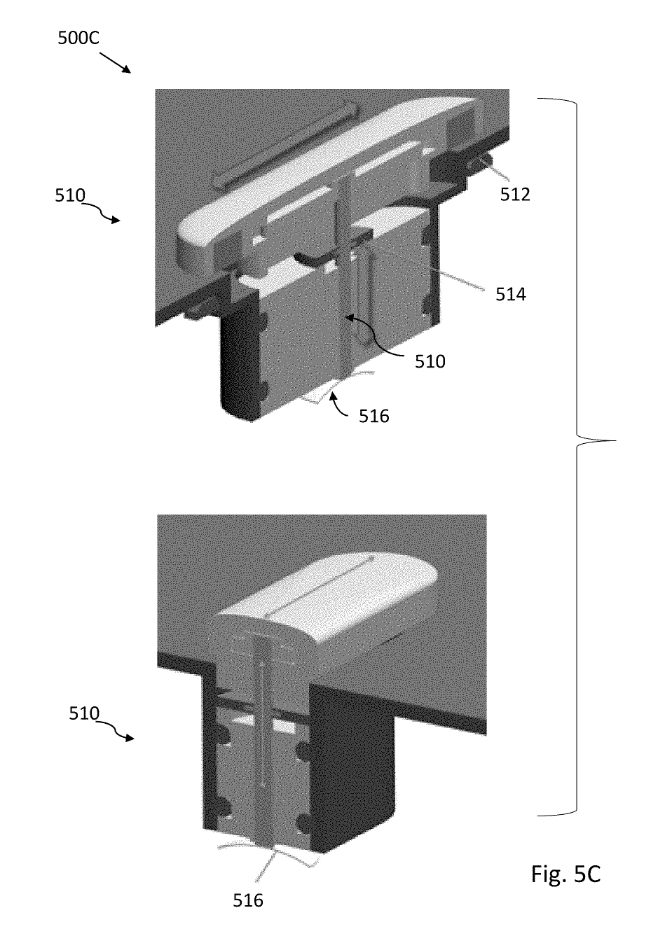

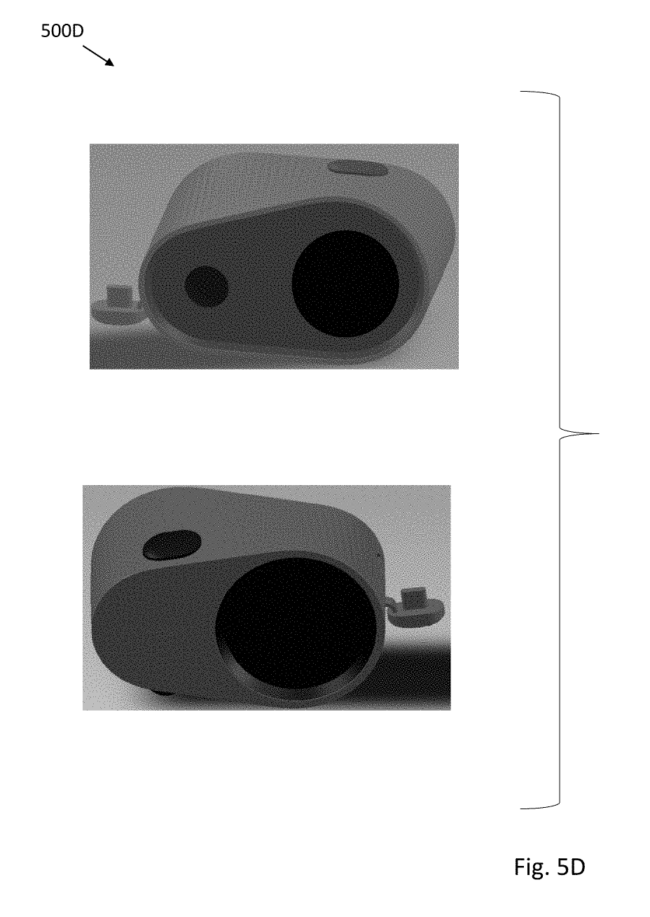

FIG. 5A illustrates one embodiment in perspective view in partial cross section. The case is bilaterally symmetrical with respect to a front portion supporting lens assemblies and a rear portion supporting a display screen. The case has a laterally extending central depression along the width of the case, both top and bottom, providing a secure handholding site for two handed operation. The top of the case has a mechanical control switch that can be activated by sliding or manual depression. As seen in FIG. 5A, internal components include a rechargeable battery, printed circuit board with control electronics, and lens assemblies.

FIG. 5B illustrates the embodiment of FIG. 5A in front, top, and rear views.

FIG. 5C illustrates an embodiment of a waterproof switch 500C with edge mounted Hall effect sensors to provide non-contact sensing. Vertical motion is allowed by a movable pin supported by a metal dome contact element 516. The pin is surrounded by a sealing diaphragm.

FIG. 5D illustrates an embodiment 500D of a viewing system having a circular viewscreen and a case design that allows for easy one-handed operation. An elastomeric plug can be used to provide a water-resistant seal for a power and data port.

In the foregoing description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The foregoing detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A viewing system, comprising:
a first optics system having a first aperture size and a first field of view of less than 15 degrees, and optics that provide a lightpath to a first sensor;
a second optics system having a second aperture sized to be less than the first aperture size, and a second field of view greater than the first field of view; the second optics system providing a lightpath to a second sensor; and
an integrated display held in a case supporting the first and second optics system, the integrated display being switchable between a first view mode in which a widefield image provided by the second sensor is displayed, and a second view mode in which a narrow field image provided by the first sensor is displayed.

2. The viewing system of claim 1, wherein the widefield images and narrow field images from are simultaneously captured as at least one of single frames (picture) or a series of frames (video).

3. The viewing system of claim 1, wherein at least one of a mechanical, electrical, or software switch is used to toggle between first and second modes.

4. The viewing system of claim 1, further comprising a target reticle on the display in the first view mode, with an area within the target reticle corresponding to the narrow field image.

5. The viewing system of claim 1, further comprising electronics supporting a downloadable application able to modify viewing system functionality.

6. The viewing system of claim 1, further comprising a communication system able to stream image or video data.

7. The viewing system of claim 1, further comprising a communication system able to simultaneously communicate with one or more of a viewing device, smartphone, or other connected devices to transfer image or video data.

8. The viewing system of claim 1, further comprising electronics supporting a machine learning module.

9. The viewing system of claim 1, further comprising a communication system able to be controlled at least in part remotely by a smartphone.

10. The viewing system of claim 1, further comprising a water/dust proof or water/dust resistant casing.

11. A viewing system, comprising:
a hand holdable casing;
a digital electronics system supported within the hand holdable casing;
a first optics system with an aperture size greater than 10 mm and a narrow field of view between 1 to 15 degrees;
a second optics system with a wide field of view greater than the first; and
a display connected to the digital electronics system and switchable between a first view mode in which a wide field image provided by the second sensor is displayed, and a second view mode in which a narrow field image provided by the first sensor is displayed.

12. The viewing system of claim 11, wherein the widefield images and narrow field images from are simultaneously captured as at least one of single frames (picture) or a series of frames (video).

13. The viewing system of claim 11, wherein at least one of a mechanical, electrical, or software switch is used to toggle between first and second modes.

14. The viewing system of claim 1, further comprising a target reticle on the display in the first view mode, with an area within the target reticle corresponding to the narrow field image.

15. The viewing system of claim 11, further comprising electronics supporting a downloadable application able to modify viewing system functionality.

16. The viewing system of claim 11, further comprising a communication system able to stream image or video data.

17. The viewing system of claim 11, further comprising a communication system able to simultaneously communicate with one or more of a viewing device, smartphone, or other connected devices to transfer image or video data.

18. The viewing system of claim 11, further comprising electronics supporting a machine learning module.

19. The viewing system of claim 11, further comprising a communication system able to be controlled at least in part remotely by a smartphone.

20. The viewing system of claim 11, further comprising a water/dust proof or water/dust resistant casing.
